(19) United States
(12) Patent Application Publication
(10) Pub. No.: US 2007/0257013 A1
(43) Pub. Date: Nov. 8, 2007

(54) Method and Apparatus for Marking a Vehicle

(76) Inventors: John T. Bell, Kent (GB); Geoffrey F. Hart, Kent (GB)

Correspondence Address: DICKSTEIN SHAPIRO LLP, 1825 EYE STREET NW, Washington, DC, 20006-5403, US

(21) Appl. No.: 11/660,494

(22) PCT Filed: Aug. 19, 2005
(86) PCT No.: PCT/GB05/03233

§ 371 Date: Jun. 20, 2007

(30) Foreign Application Priority Data
Aug. 19, 2004 (GB) 0418546.8
Jun. 27, 2005 (GB) 0513059.6

(51) Int. Cl. B23K 26/10

(52) U.S. Cl. 219/121.68

(57) ABSTRACT

In order to provide an apparatus (1) and method for marking a road vehicle, which minimises the scale of constructions placed on a factory floor, the apparatus comprises, a marking vehicle (4) comprising a motor for driving the marking vehicle, a laser emitter, a laser beam delivery means (5) for delivering a laser beam from the laser emitter to a selectable position of the vehicle and a marking head (28), contactable with a part of a road vehicle to be marked and configured to direct the laser beam to define a pattern. In a preferred embodiment, the marking vehicle is driven on a floor surface (2) which includes a road vehicle station. A two-dimensional electricity power supply grid (8) is preferably mounted above the vehicle station, the marking vehicle (4) being provided with a contact (7) for contacting the electricity power supply grid (8) and for supplying electrical power obtained from the power supply grid to the marking vehicle.

There may also be a detectable track (3), formed on the floor surface, surrounding the road vehicle station, the marking vehicle (4) comprising a motor for driving the marking vehicle, steering means for steering the marking vehicle and a detector for detecting the detectable track (3), the steering means being controllable to steer the marking vehicle to follow the detectable track detected by the detector.

The present invention relates to an apparatus and a method for marking a vehicle.

Vehicle marking is particularly important as a method of discouraging theft of vehicles. If at least one indelible mark is applied to a part of the vehicle, it will be difficult for thieves to disguise the identity of the stolen vehicle when they try to sell it. Indelible marks can be applied to secret or enclosed spaces within the structure. However, such marks have the disadvantage that they are not readily viewable by purchasers. A highly visible indelible mark is required to deter theft.

Accordingly, a practice has arisen of applying marks to an outer surface of a vehicle in a position in which they will be readily visible. These marks may be made in any suitable part of the structure. However, it is particularly preferred to make the marks in the windows of the vehicle. It is usually not possible to remove a mark from window glass. The windows of the vehicle cannot be covered or painted over by a thief to disguise the identity of the vehicle. It is impossible to remove a mark which is etched into window glass without either repolishing the entire surface or leaving a clear indication that the glass has been tampered with.

It is well known in the art to apply a mark to the window glass of a vehicle by an etching process. Typically, a stencil is used to define a unique code which allows the vehicle to be identified, an etching chemical being applied through the stencil to the window glass. Typically the etching material comprises hydrogen fluoride or related materials. However, these are very dangerous materials to handle and the process is extremely difficult to automate.

An apparatus for making a mark in window glass is disclosed in EP-A-1340585. In this apparatus, a structure is provided, typically defined by an array of beams and columns, to define a vehicle station. The structure mounts a laser emitter which is movable between different laser mounting stations of the structure. The laser emitter is equipped with laser beam delivery means in the form of an arm which terminates in a marking head. The laser emitter can be moved to a suitable laser mounting position and an operator can the manoeuvre the marking head, on the flexible laser beam delivery means, so that it is in contact with a window of a vehicle. The laser, which is suitably a carbon dioxide gas laser, is then used to make a mark on the window glass. The apparatus of EP-A-1340585 has proved to be very effective in making marks on the window glass of vehicles in a fashion which is reliable and rapid which can be integrated into a control system for ensuring that the correct marks are made on each vehicle.

However, a number of problems have arisen with the design. The structure is relatively bulky and requires to be assembled in situ on to a factory floor. It is difficult to subsequently move it or reposition it. In modern factory practice, where redesign of factory layouts can be quite frequent, this is a significant disadvantage.

The inventor has realised that it would be beneficial to mount a laser emitter and laser beam delivery means on a marking vehicle which can be driven around a road vehicle without requiring a complex structure to support it.

Accordingly, the present invention provides an apparatus for marking a road vehicle comprising a marking vehicle for running on a floor structure, the marking vehicle comprising a laser emitter, a laser beam delivery means for delivering a laser beam from the laser emitter to a selectable position of the road vehicle and a marking head, contactable with a part of a road vehicle to be marked and configured to direct the laser beam to define a pattern, whereby the marking vehicle can be driven to positions adjacent different parts of a road vehicle, so that different parts of the road vehicle can be marked.

The invention further provides a method of a marking a road vehicle comprising using the apparatus of the invention.

Preferred features of the invention will now be described.

Structures

Preferably, the marking vehicle can be run on any type of floor structure. This may include a floor surface or road surface. The floor structure may comprise a factory floor surface. The road surface may be inside or outside a building. It may be part of a factory or it may be part of a vehicle maintenance facility. Any floor structure capable of supporting the weight of a motor road vehicle should be capable of supporting the weight of the marking vehicle.

The floor structure may be adapted to be used with the marking vehicle. The floor structure may include a track for guiding the marking vehicle. The track may be of a contacting type. For example, rails or guides may be provided along which the marking vehicle may run. The tracks or guides may physically constrain the movement of the marking vehicle. Alternatively, the marking vehicle can be guided by a track of the type which does not guide the vehicle by physically steering it or by contacting it. For example, the marking vehicle may comprise steering means for steering the marking vehicle, a detector for detecting a detectable track, the steering means being controllable to steer the marking vehicle to follow the detectable track detected by the detector. The detectable track will be described further below.

A track of this kind can be easily applied to a floor structure without complicated constructions. It can be moved relatively easily or reconfigured relatively easily.

The floor structure may comprise a structure mountable on the ground or a floor surface. Preferably, such a structure does not extend very far above the ground or floor surface. Preferably, it extends for less than 0.5 m and preferably less than 0.2 m above the ground or floor surface. Preferably, the structure comprises at least one ramp which allows a road vehicle to be driven onto the structure. The structure may comprise tracks for guiding the marking vehicle as described above.

The floor structure of the present invention preferably defines a road vehicle station onto which a road vehicle may be driven so that the road vehicle can be marked. The marking vehicle may be driven around a part or the whole of the road vehicle station.

The apparatus according to the invention may include other structures. For example, it may comprise power supply structures. For example, an electricity power supply grid may be mounted above a road vehicle station, as described below.

A data controller may be mounted adjacent a road vehicle station as described further below.

All of these structures may be relatively lightly constructed, as they will not be required to support the weight of a laser emitter. Accordingly, much lighter simpler structures are required than the gantry which is shown in EP-A-1340585.

It is an advantage of the invention that rigid, permanent structures need not be formed extending to a significant height from a floor surface.

Detectable Track

A detectable track may comprise any kind of track which can be detected by a detector mounted on the marking vehicle and which does not physically constrain the movement of the marking vehicle. For example, the detectable track may be detected by electromagnetic radiation, for example infrared, visible or ultra violet light. The detector on the marking vehicle may comprise a detector for the appropriate kind of electromagnetic radiation, for example comprising means for forming an image of a part of the floor structure and image analysis means for determining the position of the detectable track within the image and for controlling the steering means of the marking vehicle so that the marking vehicle follows the detectable track.

Illuminating means may be provided for illuminating the track with the appropriate kind of electromagnetic radiation, if ambient illumination is not sufficient.

The detectable track may alternatively comprise one or more tracks selected from:
1. a magnetic or magnetisable material, detectable by a magnet or magnetic field sensor mounted in the marking vehicle,
2. means for generating an electric field which is detectable by an electric field detector mounted in the vehicle,
3. a thermal emitter, for example a heated strip which is detectable by heat detector mounted in the marking vehicle,
4. a textured surface which is detectable by a texture detector extending from the marking vehicle,
5. a vibration generator to generate vibrations, which are detectable by a vibration detector mounted in the marking vehicle, or
6. any other suitable means or any combination of the above.

The detector of the marking vehicle is preferably of the type which can sense a property of the floor structure to determine if the detectable track is present on the part of the floor structure detected. This is in contrast to known guiding—tracks where a part of the marking vehicle must stay in contact with the track in order to be guided.

The detectable track suitably defines a closed loop surrounding a road vehicle station. Suitably, the loop is of oblong or rectangular pattern. For ease of marking vehicle guidance, the corners of the pattern can be rounded. Suitably, the detectable track defines a figure of a width in the range of 2.5-5.0 m, preferably 3.0-4.0 m in width and 3.5-7.0 m more preferably 4.0-6.0 m in length.

The guide means on the floor structure for guiding the vehicle may comprise any suitable configuration. For example, it may comprise a straight, branched or curved track. It may comprise a loop. It may comprise cross overs or points or switches so that the marking vehicle can be directed to selected different tracks.

Marking Vehicle

The marking vehicle suitably comprises a wheeled vehicle. There may three or four wheels. The marking vehicle may be a track-laying vehicle. It may be provided with caterpillar tracks of types known in the art. This is particularly suitable where the floor structure on which the marking vehicle may be driven is rough or uneven.

The marking vehicle preferably comprises a motor for driving the marking vehicle, to propel it over the floor.

Steering means may be provided for guiding the marking vehicle. Steering means may comprise any suitable type of steering means. For example, at least one of the wheels may be pivotally mounted for directing the motion of the marking vehicle. The wheels or tracks may capable of being driven in a differential fashion.

The marking vehicle may comprise contact means for contacting a power supply means as described below.

The marking vehicle may comprise a transformer for transforming electrical power obtained from a power supply grid, if appropriate.

The marking vehicle may comprise a commercially available vehicle. It may comprise a self-propelled pallet truck. The vehicle may be driven by an operator who walks alongside the marking vehicle or it may be large enough for the operator to ride on the marking vehicle.

The marking vehicle may comprise a laser unit, comprising at least the laser emitter and optionally also a laser controller, mounted on the forks of the pallet truck. There may be a battery unit, also mounted on the forks of the pallet truck as explained further below.

The vehicle may be self-steering. It may be steered in response to a detectable track as explained above. It may be provided with means for the sensing a road vehicle, to prevent the marking vehicle colliding with the road vehicle. The sensor is preferably a non-contacting sensor. The sensor may comprise a magnetic sensor, radio frequency sensor, light sensor or an ultrasound sensor. It is particularly preferred to use an ultrasound sensor. For example, a two wire ASI system may be used.

In a preferred embodiment, the sensor comprises three sensor units each of which can independently sense the presence of a road vehicle. In this way, the sensor can also determine the orientation of the road vehicle with respect to the marking vehicle. The three sensor units are preferably mounted along the driving direction of the marking vehicle, and the sensor units may be connected to a controller. The controller may be configured to receive signals from the sensor units. The controller may be configured so that, if the sensor units each detect the road vehicle at the same distance, no steering correction is required, as the road vehicle is determined to be parallel to the driving direction of the marking vehicle. If the sensor units detect different distances to the road vehicle, the controller may be configured to give a signal indicating that the marking vehicle is not moving parallel to the road vehicle. The marking vehicle may be configured to respond to this signal in various ways. It may be configured to make a steering correction so that the marking vehicle progresses with its driving direction parallel to the edge of the road vehicle. It may stop the movement of the marking vehicle. It may give a signal to an operator to alert the operator that a collision may occur.

If any or one of the sensor units ceases to detect the presence of a road vehicle, the controller may be configured to give a signal indicating that the marking vehicle has moved away from the road vehicle. The marking vehicle may be configured to respond to this signal in various ways. It may give a signal to a user indicating that the marking vehicle has to be brought close to the road vehicle again. The marking vehicle may commence a manoeuvre in order to allow it to reposition itself with respect to the vehicle. For example, as most road vehicles are substantially rectangular in plan, the marking vehicle may be configured to turn itself through 90° to start to track a different face of the road vehicle. A turn may be achieved by simply turning in the direction required or by completing a turn of 360° minus the required turn angle in the opposite sense (which may be beneficial if the turning radius available to the marking vehicle cannot be accommodated in the immediate vicinity of the road vehicle). It may comprise a manoeuvre comprising several manoeuvre steps in which the marking vehicle proceeds in different directions. For example, the marking vehicle may be configured to continue in a straight line for a predetermined distance, reverse along a curved path for a predetermined distance, and then proceed forwards until the road vehicle is detected.

More sensor units may be provided if required. For example, a second set of three sensor units may be provided, for determining the shape of a road vehicle which is near the marking vehicle.

The marking vehicle may comprise stabilisers to prevent it falling over. The stabilisers may comprise structures extending outwardly from the driving axis of the vehicle, for example outriggers, skirts or any other suitable structure.

Power Supply

The marking vehicle may be powered by any suitable power supply. It may comprise electrical cells, for example batteries or accumulators. The batteries may be rechargeable, for example at a recharging station. It may comprise an internal combustion engine for powering the vehicle and for supplying electrical power for the laser emitter.

A generator may provide a current supply which is adequately clean and constant for use with the apparatus of the present invention. The electricity supply may be separate from the marking vehicle.

For example, an electricity supply mounted on a separate vehicle or an electricity supply mounted on a container or pallet may be provided, connected to the marking vehicle by an electrical conductor.

The marking vehicle may be supplied with an electrical power supplied by the electricity mains or a factory power supply or (if on board a ship) a shipboard power supply.

Power may be supplied to the vehicle by a flexible cable. In order to prevent tangling of the flexible cable, a cable reel may be provided for reeling in the cable to keep it taut.

Alternatively, the marking vehicle may comprise contact means for contacting a stationary power supply means. For example, the marking vehicle may be supplied with electrical power through rails. The rails may be guide rails on which the marking vehicle is guided.

A two-dimensional power supply grid may be provided, for example mounted above the road vehicle station. For example, it may be mounted at a distance in the range 2.0-3.0 m above the road vehicle station.

Suitable electrical power supplies may be as supplied by VAHLE Electrification Systems of Germany.

Overhead or underfloor power supply systems may be used.

Power may be supplied by a battery pack. The battery pack may for example comprise a plurality of rechargeable accumulators. Preferably, it a 24 volt power supply. Preferably the battery pack is rechargeable. The battery pack may be removably mounted on the marking vehicle. For example, a marking vehicle may be provided with at least two battery packs, one of which is mounted on the vehicle for supplying power to the marking vehicle and at least one other battery pack is connected to a charging station. Where a pallet truck system is used as described above, the battery pack may be configured to be loaded onto at least part of the pallet truck, where it may be connected to supply power.

An inverter may be provided for converting the DC supply from the battery pack to AC. A separate battery pack may be provided for the motor for driving the marking vehicle, so that the different power supplies are kept separate. The separate battery pack is preferably rechargeable.

Laser Emitter and Laser Beam Delivery Means

In order to mark windows of a vehicle, the glass itself may be marked or, alternatively, the organic inter layer formed between sheets of laminated glass may be marked. In the first process, a laser beam must be used which is strongly absorbed by glass. It is found that the laser beam emitted by a carbon dioxide gas laser (having a wavelength of 10.6 micrometers) or an excimer laser is suitable for this purpose.

For the second approach, a laser beam may be used which is not absorbed by glass but is absorbed by the organic interlayer. In this case, it is found that the beam generated by a neodymium/YAG laser may be used.

In the method in which a mark is formed in the glass itself, it has been found that, in order to avoid cracking the glass and in order to provide a mark which has clearly defined edges, a pulsed laser is suitably used. The frequency of pulsing is suitably in the range 10-100 kHz, more preferably 30-60 kHz, most preferably 35-45 kHz.

The average power of the laser is suitably in the range 5-20 watts.

Further comments on the parameters of the laser operation are given below in the section headed “marking parameters”. The carbon dioxide laser may be a high frequency excited carbon dioxide laser, preferably excited at a frequency in the range 10-50 MHz. A radio frequency excited carbon dioxide laser may be used. A slab laser may be used.

The laser emitter suitably comprises a radio frequency excited carbon dioxide slab laser of the type described in EP-A-1340585.

Suitable radio frequency excited carbon dioxide slab lasers are manufactured for example by the company Rofin Sinar UK Ltd.

The laser output may be steady, as in a continuous wave laser, or it may be pulsed. This kind of laser may require cooling means. The cooler may be liquid or air-cooled. The cooler is suitably mounted on the marking vehicle adjacent to the laser emitter or may be contained with the laser emitter in a common structure, such as a cabinet. Further, the radio frequency excited carbon dioxide slab laser will require a supply of radio frequency exciting alternating current. This supply may be mounted on the marking vehicle as well.

The operation of the radio frequency supply source may be as described in EP-A-1340585.

The laser used in the present invention may also be used to mark other parts of the vehicle than the windows, including headlights, plastic parts, painted body work or alloy wheel trims.

In an alternative embodiment, a carbon dioxide laser is used which is pulsed by the use of a Q-switch. The Q-switch may be internal to the laser emitter or external to the laser emitter. A Q-switch in the optical path provides laser pulses of extreme short time duration. The Q-switch may be a rotating prism, a Pockels cell or a shutter device to create a pulse.

The use of a carbon dioxide laser with a Q-switch has been found to be particularly valuable because it allows a relatively light weight emitter to be used without requiring a heavy and complex source of radio frequency to excite the laser.

Suitable forms of light weight carbon dioxide laser include the SYNRAD (Trade mark) Series 48 lasers or a carbon dioxide laser with an integral Q-switch available from DEMARIA Electro Optic Systems. WO02/082600 discloses a Q-switch cavity dumped carbon dioxide laser for material processing which is suitable for use with the invention. A second laser emitter may be provided, which can be used if the first laser emitter fails.

The laser beam delivery means is preferably substantially as described in EP-A-1340585.

It is required to provide a flexible path extending from the laser emitter to an exit point, which path is totally enclosed, to protect operators and other equipment from damage.

Laser beam conduits which meet these requirements are well known from the art of laser beam welding. A suitable laser conduit comprises at least two laser conduit sections joined together at connections, the conduit sections being rotatably mounted with respect to one another at the connections about one and preferably two axes. Preferably, there are at least three, most preferably at least four laser conduit sections. Preferably, the connections between laser conduit sections comprise mirrors for steering the laser beam at the connections where the laser conduit sections meet at an angle. An apparatus of this type is well known in the art of laser beam welding. The laser beam conduit sections may be substantially straight or they comprise two sub-sections rigidly joined together at an angle. In this case, a turning mirror may be provided within the laser conduit for turning the laser beam at the angle. Suitable apparatus is obtainable for example from Laser Mechanisms Inc., Southfield Mo. United States. In order to obtain a wide range of movement there are preferably at least three connections, the laser beam conduit sections being rotatable at each connection about two axes, suitably two axes at right angles.

The laser beam conduit sections may be made rotatable with respect to one another about two axes by providing connections which comprise a first engagement part, rotatably connected to a first laser beam conduit section, rotatable about a first axis and a second engagement part, rotatably mounted with the respect of the first engagement part. Each engagement part may comprise a laser turning mirror. The second engagement part may also be rotatably mounted with the respect to a second laser beam conduit section, to give optimum flexibility.

The laser conduit sections may be provided with protective material, for example a resilient coating, to further protect them from damage.

The present invention allows the laser beam conduit sections to be relatively short. For example, each section may be no more than one metre long, preferably no more than 800 mm long and preferably no longer than 700 mm and preferably in the region 400-650 mm in length. In particular, it is found that, in order to avoid accidental damage of the laser beam delivery means by collision with other objects or damage to other objects or damage to other objects, it is desirable to keep the individual laser beam conduit section length as short as possible. The entire laser beam delivery means is suitably no more than 3.0 m in length, preferably no more than 2.5 m and preferably less than 2.3 m in length.

The internal diameter of the laser beam conduit is suitably in the range 30-50 mm. The external diameter is suitably in the range 50-100 m more preferably 70-90 mm.

Means may be provided for suspending the weight of the laser beam delivery means and marking head. For example, the weight may be suspended by a cable which extends from a supporting structure. The supporting structure may comprise a rigid supporting member which extends upwardly from the marking vehicle and a supporting arm, rotatably mounted on the supporting member for rotation in a substantially horizontal plane. The supporting arm may comprise a first section and a second section which is slideably mounted with respect to the first section, so that the length of the arm may be freely varied. The cable supporting the weight of the laser beam delivery means may be mounted on a tensioned reel. In this way, the height at which the laser beam delivery means is suspended may be varied. For example, a locking reel may be used.

The weight of the marking head and the laser conduit sections may be supported by resilient means comprising compensating systems of the type known in the art. The compensating system preferably comprises resilient means, for example a spring, provided at each rotatable connection, the resilient means tending to oppose the weight which will tend to displace the conduit sections downward. To do this, the spring constant and initial loading of the resilient means can be set, in a manner known to the person skilled in the art, so that the weight is always substantially balanced by the resilient force of the resilient means.

The laser beam delivery means may comprise a telescopic section for extending outwardly.

The laser beam delivery means may comprise a fibreoptic cable. It may comprise a flexible waveguide. Where a flexible waveguide is produced, it may comprise a beam contractor, for contracting the laser emitted by the laser emitter at the beginning of the waveguide and a beam expander for expanding the laser beam at the exit of the waveguide. For example, the laser beam maybe contracted from 6 mm to 1 mm and expanded again from 1 mm to 6 mm.

A flexible waveguide or fibreoptic cable may be 2-3 meters in length.

Means may be provided for preventing the radius of curvature of the cable being reduced below a certain value. This is because of a danger of heat concentration and burning if the radius of curvature is too small, for example less than 50 mm. For example, armoured cable segments of a type used in radio frequency cable construction may be used.

A suitable flexible waveguide is available from Lasermech.

Marking Head

In the marking apparatus of the invention, the laser emitter produces a pulsed or continuous laser beam which is delivered via delivery means to the marking head.

The marking head is adapted to contact the part of the road vehicle to be marked, and deliver the laser beam to the part of the road vehicle to marked, the marking head further including means for deflecting the laser beam to define a pattern required to form the mark.

The mark formed may be of any suitable type, for example an alpha numeric code of specified number of characters in a specified number of rows. Alternatively, it may comprise a graphic symbol, logo or other mark. In all cases, it is necessary to move the laser beam across the surface of the part of the road vehicle to be marked in two dimensions. The mark may be formed in a dot matrix pattern by scanning the laser beam across the surface of the part of object to be marked in a rasterscan pattern. Alternatively, the characters can be scribed individually.

In order to deflect the laser beam in two dimensions, any suitable system may be used. However, preferably at least one mirror is provided which is rotatable about at least one axis to deflect the laser beam. Preferably, a pair of mirrors in sequence are used, each intersecting the laser beam and each being rotatable about a respective fixed axis. Preferably the axes about which the mirrors are rotatable are orthogonal to one another. The rotation of the mirrors is controlled by any suitable means. Preferably, the rotation of the mirrors is controlled by galvanometers which are found to move quickly and effectively. A suitable arrangement is described for example in U.S. Pat. No. 5,298,717.

The marking head will further comprise a light-tight casing for preventing leakage of laser radiation, to protect operators.

A part of the casing will comprise a window of a material which is transparent to the laser radiation used. For example, where a carbon dioxide laser is used (as discussed further below), the window may comprise germanium.

The marking head will suitably comprise control means operable by the operator.

The control means suitably include means for commencing laser marking when the marking head is in position.

The control means preferably includes a safety device. The safety device suitably comprises at least one switch which is only closed when the marking head is in the correct position on a part of the road vehicle to be marked, in order to prevent the apparatus being accidentally fired. Preferably, there are at least three switches, all of which have to be depressed when the marking head is in correct position, the laser being inoperable until all three switches are depressed. This ensures that the marking head is in position before the laser is fired to prevent distortion of the mark applied and to prevent escape of laser radiation.

The marking head may further comprise a resilient seal around the marking head to further prevent leakage of radiation.

Means may be provided for cleaning the laser beam window to prevent loss of light or focus. For example, an air jet may be provided for blowing deposits off the laser beam window and to prevent contamination of lenses.

Preferably, means are provided for collecting material released during the marking of the window glass. For example, glass dust may be collected. The collecting means may comprise a simple container. However, in order to catch the relatively light particles of glass, an adhesive surface may be provided. For example, a piece of double sided adhesive tape may be employed.

Preferably, the marking head is of light weight. Preferably, the weight of the marking head does not exceed 5 kg, being preferably less than 3 kg suitably less than 2 kg. A suitable design of marking head is the HS7 or ScanCube (trademark) available from Scanlab (trade mark). Other suitable marking heads can be obtained from the manufacturer Rofin Sinar.

Marking Parameters

The marking parameters are substantially as described in EP-A-1340585.

In order to control the operation of the laser emitter and the marking head to produce the required mark, a controller is required. Data may be input to the controller by input means. The input means and controller may be substantially as described in EP-A-1340585.

However, in the present invention, the controller is suitably mounted in the marking vehicle. In order for the controller mounted on the marking vehicle to be contact with external fixed data sources, any suitable connection may be provided. For example, a data loading position may be provided for the marking vehicle, in which it can be connected, for example by a plug in cable, to a data supply, the data in the controller mounted in the marking vehicle being updated every time the marking vehicle returns to the data loading station.

Alternatively a wireless data transfer system may be provided, for example a microwave or radio frequency data transfer system.

The present invention will be described further below by way of example of only with reference to the accompanying drawings, in which:

### BRIEF DESCRIPTION OF THE DRAWINGS

FIG. 1 is a sketch isometric view of a first embodiment of apparatus according to the first and second aspects of the invention.

FIG. 2 is a sketch cross sectional view through the marking vehicle of FIG. 1.

FIG. 3 is a sketch view of a second embodiment of apparatus according to the first aspect of the invention.

### DESCRIPTION OF PREFERRED EMBODIMENT

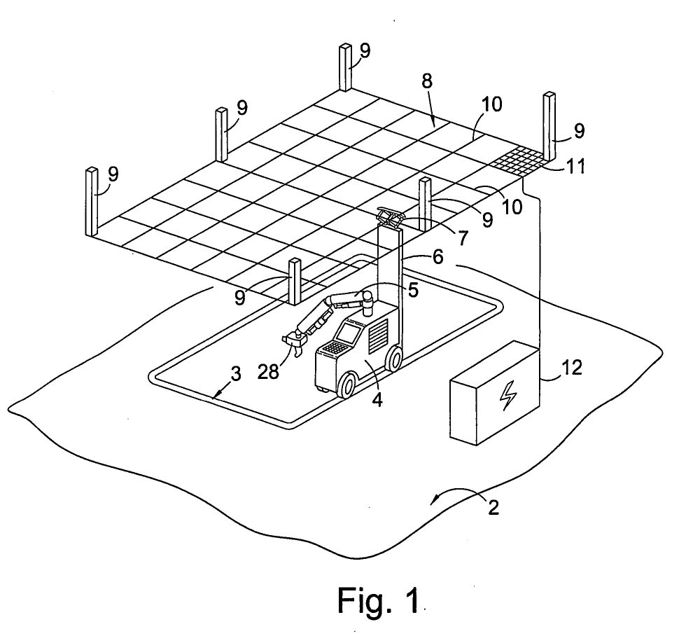

FIG. 1 shows a laser marking apparatus for marking a vehicle, generally designated 1.

The laser marking apparatus is assembled on the factory floor surface 2 in a manner which requires very few fixed structures on the surface 2.

A detectable track 3 is shown, formed on the floor surface 2, defining a generally rectangular figure with round corners, enclosing a road vehicle station, in which a road vehicle may be parked in order to be marked.

A marking vehicle 4 is provided which, as will be described further below, has a detector for guiding it around the detectable track 3, so that it can be moved to any side of the vehicle. This allows the vehicle to be marked using a laser which is mounted in the marking vehicle 4 and which generates a laser beam which is transmitted by laser beam delivery means 5 to a marking head 28 which can be placed in contact with the part of the road vehicle to be marked.

The marking vehicle further comprises a power collector 6 in the form of a mast having a pantograph 7 mounted thereon. The pantograph 7 contacts a power supply grid 8 which is mounted by structures 9 to a ceiling structure (not shown).

The power supply grid 8 may be of any suitable design, for example, comprising a plurality of main grid members 10 defining a substantially square grid, with intermediate power supply members 11 formed therebetween. The intermediate power supply members are shown in only one part of the grid 8, for clarity.

A suitable power supply 12 is provided for supplying electrical power to the power supply grid 8.

The detectable track 3 in this case comprises a distinctly coloured track painted on the floor or applied to the floor using adhesive tape, which can be detected by a detector mounted in the marking vehicle, as will be described further below.

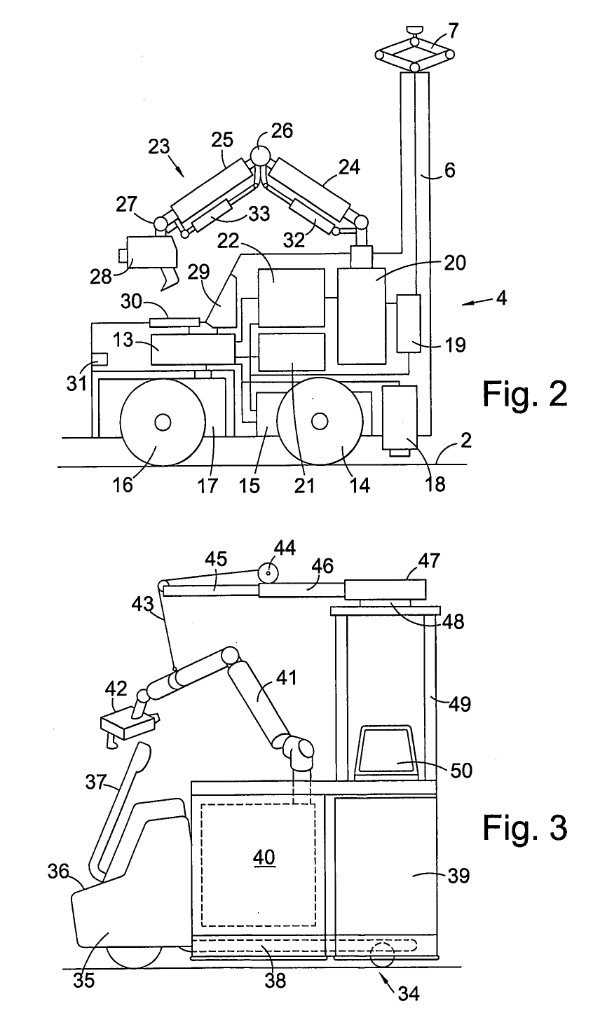

FIG. 2 shows a schematic cross section through the marking vehicle of FIG. 1. The marking vehicle 4 comprises a body in which the following components are mounted.

A first set of wheels 14 is provided, drivable by a motor 15. A second a set of wheels 16 is provided which is steerable by a steering mechanism of a type known in the art.

A detector 18 is provided configured to sense a part of the floor surface 2 on which the marking vehicle 4 stands, to detect the detectable track 3, as will be described further below.

The detector 18 sends signals to a controller 13 which analyses the signals and provides some steering control signals to the steering mechanism 17 as will be described further below.

The marking vehicle comprises a mast 6 on which is mounted a pantograph 7 for collecting power from the power supply grid 8. Power is supplied to a transformer 19 and supplied to various elements of the marking vehicle 4.

The marking vehicle 4 further comprises a laser 20 in the form of a radio frequency excited carbon dioxide slab laser.

A supply of cooling water 21 is mounted adjacent the laser emitter. The laser may alternatively be air cooled.

A radio frequency supply 22 is mounted adjacent the laser for exciting the radio frequency excited carbon dioxide slab laser.

The controller 13 is configured to control the operation of the laser, and the excitation of the laser by the radio frequency source 22.

A laser beam delivery means 23 in the form of flexible arm is provided. The laser beam delivery means comprises two conduit sections 24 and 25 in succession, each being provided with protective covering, to prevent them from being damaged. The laser beam conduit section 24 is rotatably mounted about a vertical axis and at least one horizontal axis to the launch point of the laser beam from the laser emitter 20. The first laser beam conduit section 24 is rotatably mounted about two axes with respect to the second laser beam conduit 25 at a connection 26 which may be of the type described in EP-A-1430585. The second laser beam conduit section 25 is rotatably connected about two axes at right angles at a connection 27 to a marking head 28, which is substantially as described in EP-A-1340585.

The weight of the marking head, and the two laser beam conduit sections are compensated at each connection by weight compensating means 32 and 33 of conventional design. The weight compensating means 32 and 33 each counter balance the weight at each connection so that the compensating force and the weight are exactly in balance. In this way, the use can move the laser beam delivery means 23 to any selected position and it will stay there once placed in that position.

The controller 13 is operable by a keypad 30 and using a screen 29.

The controller 13 is in communication with a central data store (not shown) by a radio connection 31.

The controller 13 is connected via a signal cable (not shown) to the marking head 28 so that the operation of the marking head can be controlled by the controller

In use, a road vehicle is driven into the road vehicle station inside the detectable track 3. The operator may use a key pad 30 or another device, for example a barcode scanner to input an identification of the vehicle to the controller 13. The controller 13 then identifies from its own data supply, or from data obtained via the radio link 31 from a central data store, information about the road vehicle to be marked, including the mark to be made on the vehicle, number of windows to be made and confirmation information, for example design of vehicle. This information is displayed on the screen 29. The operator then commences marking the road vehicle by inputting a command to the marking vehicle 4 to proceed to a first station. The controller 13 will be programmed with marking vehicle drive instructions, for driving the marking vehicle 4 between a series of marking stations in sequence, the marking stations being selected so that, at each marking station, the marking vehicle 4 will be positioned in a suitable place for the operator to bring the marking head into contact with a window of the road vehicle to allow easy marking.

The operator then manually draws the marking head 28 into a contact with a window of the vehicle to be marked and, using control buttons of the type described in EP1340585, commences marking. Once the window has been marked, the operator then marks the next window or commands the marking vehicle 4 to move to the next station as appropriate.

In order for the marking vehicle to follow the detectable track 3, the detector 18 senses an area of the floor 2, which area may include the detectable track or a portion of the detectable track 3. The detector 18 may be configured to determine a vector representing the direction into which the detectable track 3 extends from a reference point. The controller 13 is then configured to operate the steering mechanism 17 in such a way that the marking vehicle 4 will follow the vector defining the direction in which the detectable track 3 extends. The controller 13 may be configured to determine the distance that the marking vehicle has traveled and, when it has traveled a predetermined distance, command the marking vehicle to stop.

In this way, the marking vehicle successively travels to the series of marking stations around the vehicle, allowing the operator to mark each window of the vehicle.

When marking is complete, the controller 13 is operated to indicate that marking is complete. The road vehicle is then driven away from the road vehicle station and another road vehicle is driven in.

FIG. 3 shows a sketch side view of a second embodiment of apparatus according to the first aspect of the invention. It comprises a self-contained marking vehicle 34. It is built on a commercially available pallet truck 35 of the type which includes an electric motor 36 which is steerable by means of a handle 37, operated by an operator. The pallet truck further incorporates a pair of forks, one of which 38 is seen extending from the motor casing 36. A first housing 40 is mounted onto the forks and held in position either by its own weight or by mechanical fixings. Inside this housing there is mounted a radio frequency excited carbon dioxide slab laser emitter, a source of radio frequency for exciting the laser and a cooler for cooling the source and the emitter. A laser beam delivery means 41 comprising a plurality of arms articulated together is provided. The laser beam delivery means terminates in a laser marking head 42 of a design corresponding to that shown in FIG. 1 and FIG. 2.

A battery pack 39 comprising a plurality of rechargeable accumulators is detachably mounted on the forks 38. In a first configuration, the battery pack 39 is securely mounted on the forks 38 and connected to the housing 40 which is thereby supplied with electric power. In a second configuration, the battery pack 39 can be disconnected from the housing 40 and the forks 38 and placed in position in a recharging station where it is recharged with electricity. At that point, a second, identical battery pack can be mounted on the forks to supply electricity to the housing 40. The battery pack 39 supplies power to the marking apparatus through a sinewave inverter to convert the 24V DC supply to 230V Ac at 50 cycles, at a power output of 2300 W. The inverter may be supplied by Studer of Switzerland.

The motor for driving the marking vehicle may be supplied with power by the battery pack 39 or by a separate power pack. If a separate power pack is used, it is preferably a rechargeable power pack and may be charged through the battery pack 39 or by a separate charger.

In use, the weight of the laser beam delivery means 41 and marking head 42 is suspended by a cable which is mounted on a pretensioned reel 44. Sufficient tension is given to the reel 44 to approximately the balance the weight of the laser beam delivery means and the laser marking head. The cable 43 can be reeled out to adjust the height of the laser marking head, with no substantial increase or decrease in tension, so that the marking head 42 and laser beam delivery means 41 remain suspended. The cable 43 passes over a pulley at the end of an arm which comprises a first arm section 45 which is slidably mounted on a second arm section 46. Because of the flexibility of the laser beam delivery means 41, the linear variability of the arm comprising the first and second sections 45 and 46 and the cable 43, the laser marking head can be freely moved into many different positions to contact the window glass of a vehicle to be marked.

The arm 46 is mounted on a turntable comprising a rotating element 47 and a fixed element 48 which is supported on a structure 49 which extends upwardly from the marking vehicle. A monitor 50 is provided to allow an operator to monitor progress of the marking operation.

The present invention has been described above by way of example only and modifications can be made within the invention. The present invention also extends to individual features described or implicit herein or any generalisation of any such features or any combination of any such features or generalisation.

1. An apparatus for marking a road vehicle comprising a marking vehicle for running on a floor structure, the marking vehicle comprising a laser emitter, a laser beam delivery means for delivering a laser beam from the laser emitter to a selectable position of the road vehicle and a marking head, contactable with a part of a road vehicle to be marked and configured to direct the laser beam to define a pattern, whereby the marking vehicle can be driven to positions adjacent different parts of the road vehicle, so that different parts of the road vehicle can be marked.

2. An apparatus according to claim 1, further comprising a floor structure adapted to support the marking vehicle.

3. An apparatus according to claim 2, wherein the floor structure comprises a track for guiding the marking vehicle.

4. An apparatus according to claim 3, wherein the track is a detectable track.

5. An apparatus according to claim 4, wherein the detectable track is detectable by electromagnetic radiation, and the detector on the marking vehicle comprises a detector for the electromagnetic radiation.

6. An apparatus according to claim 5, wherein the detector comprises means for forming an image of a part of the floor and image analysis means for determining the position of the detectable track within the image and for controlling the steering means of the marking vehicle so that the marking vehicle follows the detectable track.

7. An apparatus according to claim 1, wherein the marking vehicle comprises means for sensing a road vehicle.

8. An apparatus according to claim 1, wherein the marking vehicle is self-steering.

9. An apparatus according to claim 1, wherein the marking vehicle comprises a motor for driving the marking vehicle.

10. An apparatus according to claim 1, further comprising a power supply for the marking vehicle.

11. An apparatus according to claim 10, wherein the marking vehicle is connected to the power supply by a flexible cable.

12. An apparatus according to claim 10, wherein the marking vehicle comprises an electrical contact contactable with a stationary contact surface of the power supply.

13. An apparatus according to claim 12, further comprising a two-dimensional electricity power supply grid being mounted above the vehicle station, the marking vehicle being provided with a contact for contacting the electricity power supply grid and for supplying electrical power obtained from the power supply grid to the marking vehicle.

14. An apparatus according to claim 1, comprising a rechargeable battery pack.

15. An apparatus according to claim 1, wherein the laser emitter is a carbon dioxide gas laser.

16. An apparatus according to claim 15, wherein the laser is a radio frequency excited carbon dioxide slab gas laser.

17. An apparatus according to claim 1, wherein the laser beam delivery means comprises at least two laser conduit sections joined together at connections, the conduit sections being rotatably mounted with respect to one another at the connections about one and preferably two axes.

18. A method of marking a road vehicle, comprising using an apparatus according to claim 1.

19. (canceled)

20. (canceled)
